(19) United States
(12) Patent Application Publication
(10) Pub. No.: US 2008/0135061 A1
(43) Pub. Date: Jun. 12, 2008

(54) Pallet cleaning station and method

(75) Inventor: Adam J. Madgar, Cortland, OH (US)

Correspondence Address: ROBERT J HERBERGER;MCLAUGHLIN AND MCNALLY, 500 CITY CENTRE ONE, P O BOX 507, YOUNGSTOWN, OH, 445010507, US

(73) Assignee: Millwood, Inc

(21) Appl. No.: 11/635,310

(22) Filed: Dec. 7, 2006

(51) Int. Cl. B08B 1/02; B08B 13/00; A46B 15/00; A47L 9/00

(52) U.S. Cl. 134/1; 134/64 R; 15/77; 15/3; 15/308; 134/56 R; 15/4

(57) ABSTRACT

A system and method for cleaning wooden pallets comprises conveying the pallets through a first stage area having regions for brushing a top exterior, a bottom exterior, all four side exteriors, a top and bottom interior and at least one pair of side interiors. Preferably, these brushes are treated with a non-stick coating and retract into separate ridged chambers when not in use to deter pallet cross-contamination. Each scoured pallet is then conveyed to a second stage area for a non-chemical, germicidal treatment, preferably including ultraviolet light irradiation.

### BACKGROUND OF THE INVENTION

1. Field of the Invention

The present invention relates to a system or station and method for cleaning pallets or the like. More particularly, this invention relates to a station and method for cleaning, decontaminating or otherwise refurbishing wooden pallets so that after processing they can be reused for various product shipping applications.

2. Description of Related Art

Several devices are known for cleaning pallets per se. For example, Herschberger U.S. Pat. No. 7,087,121 shows a rotary brush device (and method) for removing sawdust from the deck of a newly made, wooden pallet. Using only an upper and lower brush (and no additional side brushes), this device combines with compressed air to mostly remove left over sawdust from unused pallets.

Foster et al U.S. Pat. No. 6,129,099 uses a plurality of high pressure, rotating jet nozzles to clean articles including pallets. Optional air blowers may supplement the water washings performed by this apparatus.

In Whitehorn U.S. Pat. No. 5,446,942, individual pallets are steam cleaned with a plurality of spraying nozzles. Similarly, a heated, pressurized fluid is sprayed on mostly plastic pallets in the portable cleaning chamber of Dobson U.S. Pat. No. 5,372,153.

For the manufacture of concrete blocks in molds, flat steel pallets are used to hold the blocks for curing. To remove flash buildup from these pallets, Coggin et al U.S. Pat. No. 4,428,090 taught using a pallet scraper that includes blade protection should pallets accidentally travel in the wrong, i.e., reverse, direction through that cleaning/scraping system. This represented an improvement over the pallet cleaning machine of Frese U.S. Pat. No. 2,799,879. For the type of pallets used in concrete pipe manufacturing, Lang U.S. Pat. No. 3,849,820 taught engaging the outer rims with several rotatable brushes. Nine years earlier, Simmons U.S. Pat. No. 3,217,348 used a reciprocating scraper blade to accomplish a similar cleaning of concrete mold pallets.

There are numerous other disclosures for cleaning block mold (rather than standard wooden) pallets. Among them are Warsaw U.S. Pat. No. 2,752,621, Beals U.S. Pat. No. 2,724,137, Moore U.S. Pat. No. 2,637,057, Wellnitz U.S. Pat. No. 2,333,285 and Collins U.S. Pat. No. 1,045,677.

Still other known pallet cleaning methods employ significant quantities of water, often sprayed in combination with other liquid chemical treatments. The present invention manages to streamline the process of decontaminating used pallets while eliminating the need for using potentially harmful chemicals. Furthermore, this invention accomplishes its goal of wooden pallet “rehabilitation” at a drastically reduced energy consumption level when compared to other currently known methods.

### SUMMARY OF THE INVENTION

It is an object of the present invention to provide a two-stage system for cleaning and/or refurbishing used pallets, especially wooden pallets. The first stage sends pallets along a conveyer into an area where a plurality of brushes directed from the top, bottom, and sides scour away surface debris from all pallet exteriors. A plurality of brushes scour debris from the top, bottom and sides to each pallet interior. Preferably, these brushes are treated with a non-stick coating, such as Teflon®, for preventing removed pallet debris from sticking to same. When not in use, these brushes may retract into ridged chambers from which removed pallet debris may be periodically removed. While the first stage is readied for processing its next used pallet, the first, fully scoured pallet is advanced to a germicidal stage or station for killing off any remaining bacteria, viruses, molds, etc. Preferably, that latter stage exposes the pallet exterior to ultraviolet light for a determined length of time. Should end use applications dictate, the inside pallet surface areas may be subjected to additional germicidal irradiation. The preferred method is waterless and requires no natural gas, applied detergents or other chemicals. It is also more energy efficient than today's known alternative means for pallet rehabilitation.

Other objects and features of the present invention will be obvious to those of skill in the art. It should be noted, however, that the drawings are designed for the purpose of illustration only and not as a definition of the limits of the instant invention, for which reference should be made to the claims appended hereto.

### BRIEF DESCRIPTION OF THE DRAWINGS

Further features, objectives and advantages of the present invention will become clearer when referring to the following detailed description of preferred embodiments made with reference to the accompanying drawings in which:

FIG. 1 is a top plan view of a first preferred embodiment schematically showing the two main stages or work stations for the invention;

FIG. 2 is a side view schematically showing the first through third regions of the first stage area for a second preferred embodiment of the invention;

FIG. 3 is a top schematic view of the first through third regions in FIG. 2;

FIG. 4 is a side schematic view focusing on the internal cleaning regions to the first stage area of a second preferred embodiment;

FIG. 5 is an enlarged bottom view of the first stage area, schematically showing the internal cleaning from FIG. 4;

FIG. 6 is a side schematic view focusing on a side cleaning regions to the first stage area of a second preferred embodiment;

FIG. 7 is an enlarged top view schematically showing the first stage area, side cleaning region from FIG. 6;

FIG. 8 is a side schematic view focusing on the second stage of pallet cleaning according to the invention;

FIG. 9 is a top schematic view of the second stage from FIG. 8; and

FIG. 10 is a chart depicting ultraviolet light intensity versus distance from item being treated with same according to one preferred embodiment of this invention.

### DETAILED DESCRIPTION OF PREFERRED EMBODIMENTS

The system of this invention is used to clean, cleanse or rehabilitate multiple pallets that are conveyed or otherwise transported through its various stages or stations. Preferably, this system and the method of disinfecting that it employs refurbishes already made and used wooden pallets or “skids”. It is not intended to clean newly constructed pallets that have yet to be used.

Pallets made of softwoods are often considered expendable. They may be discarded as trash, along with wrapping elements, after the item being transported reaches its final destination. Such pallets typically permit lifting from only one or opposite ends. Hardwood pallets, capable of being lifted from all four sides, are costlier to make. Their construction can vary with end use, i.e., general non-food versus FDA-compliant, long term storage and possible chemical contacting. If exporting outside the U.S. is anticipated, still other rules will apply. The National Wooden Pallet & Container Association has developed a pallet design system (PDS) for generating the best options for a given product load.

The hardwood pallet most commonly made and sold measures 48 inches long by 40 inches wide by 5 inches deep. Known as the GMA or “grocery” pallet, it is used for nearly thirty percent (30%) of all domestic applications. While the system and method of this invention are intended to primarily disinfect this wooden pallet size for reuse, it is to be understood that reasonable and inexpensive modifications to same will allow the system to be used for still other wooden pallet shapes and sizes, and/or to rehabilitate-refurbish non-wooden alternatives including those pallets made of plastics, composites, metals and/or combinations of same.

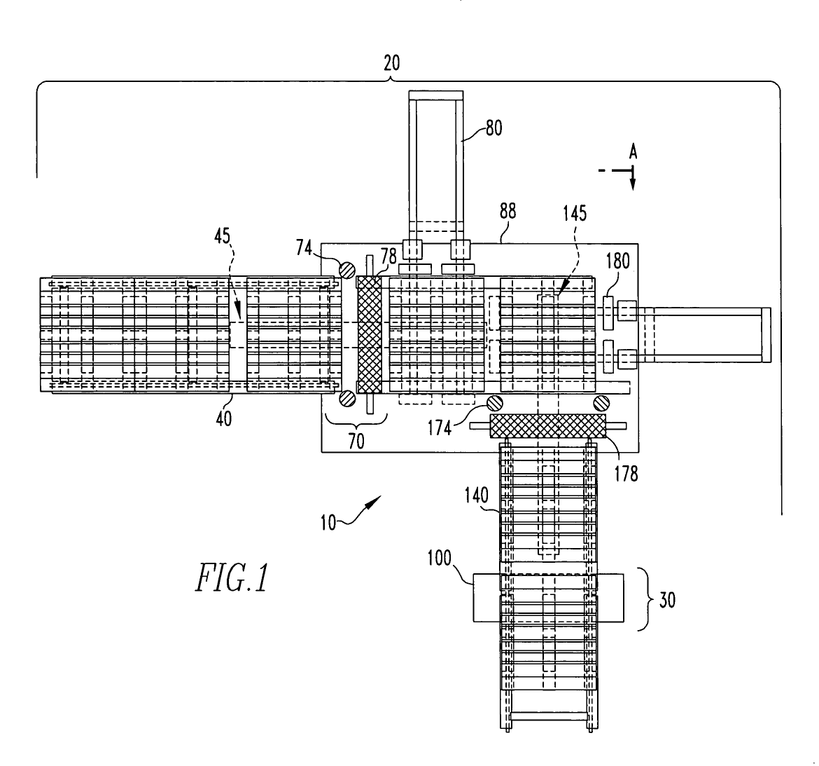

Referring now to FIG. 1, there is shown a first preferred embodiment of cleaning system, generally 10, in which a plurality of pallets are passed for cleaning and disinfecting. The system 10 consists of two main stages, a first stage area 20 having separate regions in which the pallet exteriors and interiors are cleaned; and a second stage area 30 for germicidal treatment. A transportation means, or pallet conveyor 40 assists in the physical transfer or passing of used wooden pallets through the aforementioned stages of system 10. Preferably, a pneumatic drag link 45 holds each pallet onto a first conveyor 40 while also forcing same through the various physical cleaning mechanisms, i.e. brushes, scrapers or the like, that will be contacting with same.

In the preferred view of FIG. 1, first stage area 20 runs mostly along a horizontal axis of a plant floor. To more efficiently accomplish the cleansing of alternate side exteriors, first stage area 20 makes a substantially ninety degree (90°) turn at angle “A”. There, each pallet transfers from first conveyor 40 to second conveyor 140 with its own pneumatic drag link 145. On the latter conveyor, the remaining pallet exterior is brushed clean before passing into second stage area 30. It is to be understood that other plant layouts and equipment may dictate still other relative floor efficiency configurations.

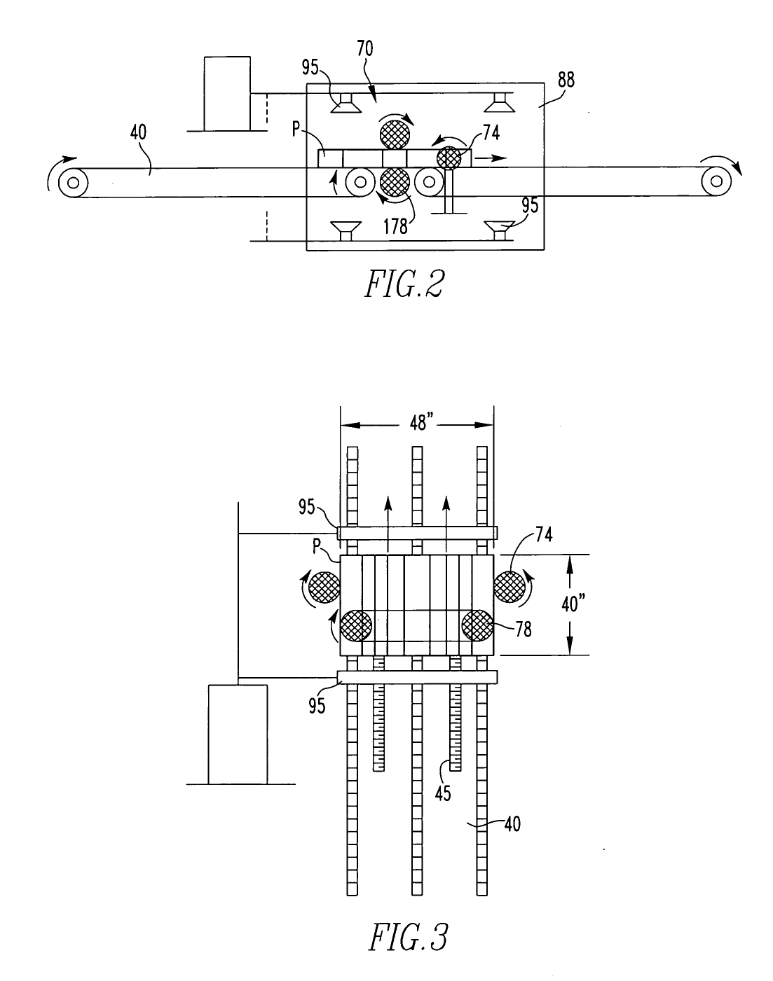

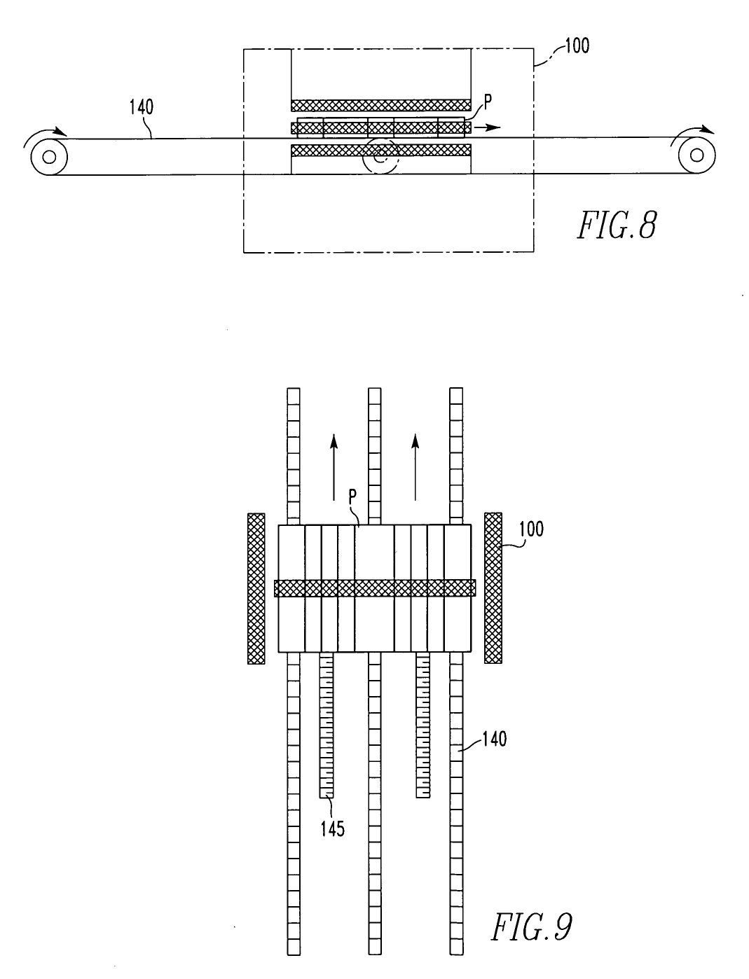

The preferred embodiments of first stage area 20 are divided into regions for ease of description. It is to be understood, however, that the transitions between regions and/or their precise order, may vary with equipment availability and/or plant floor layouts. The first preferred embodiment of FIG. 1, for example, has a distinct difference in first stage area subdivisions from the second preferred embodiment of FIGS. 2 through 9. The subtleties of these will be described in more detail hereinafter.

In either arrangement, there is a first region for cleaning or brushing a top exterior of each pallet. In FIG. 1, first region (generally 70) has been combined with a first station or region for cleaning a first pair of side exteriors. That late side cleaning region is designated as region 74. As actually drawn, first side exterior cleaning region 74 immediately precedes a roller brush 78 that scours the entire, upper exterior to a used pallet passing beneath.

In FIG. 1, while there is a second region for brushing a bottom exterior of each pallet using lower roller brush 178, that region is not immediately adjacent first region 78, for concurrently or near simultaneously cleaning both upper and lower pallet exterior surfaces. Instead, second region with its lower brush 178, in FIG. 1, follows the right angle turn in the assembly line-like cleaning station. There, this final pallet exterior brushing immediately precedes pallet entry into second stage area 30.

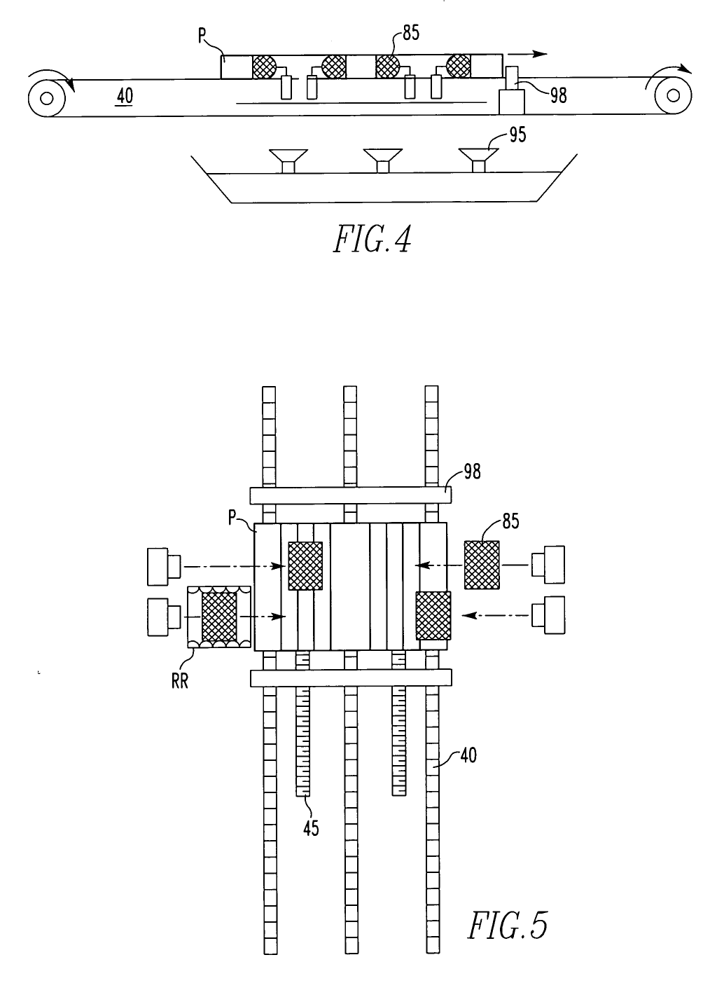

In FIG. 1, a third region for brushing a first pair of side exteriors actually appears as part of first region 70. The relative “fourth region” for cleaning the alternate pair of side outer surfaces is shown as item 174 immediately preceding the lower brush 178. After the first pair of side exterior brushes, this first embodiment employs a plurality of cross brushes on a first set of reciprocating (both up-and-down and left-to-right) stroker arms 80. These stroker arms achieve a near simultaneous cleansing (or brushing) of both pallet top and bottom interiors. As first stroker arms 80 may not reach every interior surface to the pallet being refurbished, a second set of stroker arms 180 scour the pallet interior surfaces (top, bottom and sides) from a right angle to first stroker arms 80. Together, these machines accomplish the fifth through eighth region cleanings for first area 20. In another main embodiment, these region divisions are more distinct and handled by buffing, sliding brushes 85 indexed to move about and over each interior pallet crevice. See generally, FIGS. 4 and 5 for this alternate configuration.

The brushes used in accordance with this invention may be treated with a non-stick coating. A representative example is Teflon®, as made and sold by DuPont. When duly treated, the pallet debris these brushes are removing is less likely to stick to or in the brush body proper thereby reducing the possibility of transferring to other pallets passing through, or cross-contamination. It is further desired that when the brushes of this system are not “in use”, they can retract into their respective chambers, depicted as a ridged region “RR” about the lower left brush in FIG. 5. While stored in its ridged region “RR”, each brush may continue to be rotated, or spun a preset time before temporary shutoff, in order to remove from the brush proper any pallet debris that has been recently removed. With proper channeling, these brush storage chambers can be periodically emptied for once more deterring pallet cross-contamination.

Ideally, much of the foregoing brushing or scouring should be conducted under a dust hood like item 88 in FIG. 1. More preferably, a plurality of vacuum heads (with attached hoses) can remove the debris from pallets being serviced for carrying away from the work area, without the need for repeated water (or other liquid) rinsing. While these vacuum heads are not shown under hood 88 of FIG. 1, they are depicted elsewhere as item 95 in several other side and bottom views of the second preferred embodiment, FIGS. 2 through 9. For mechanically stopping each pallet at desired cleaning points along the conveyor system of this invention, air hydraulic or servo driven stops, like tem 98 in FIGS. 4 and 5 are included. They may be supplemented with, or fully replaced by visual (i.e., infrared or laser) sensors, not shown.

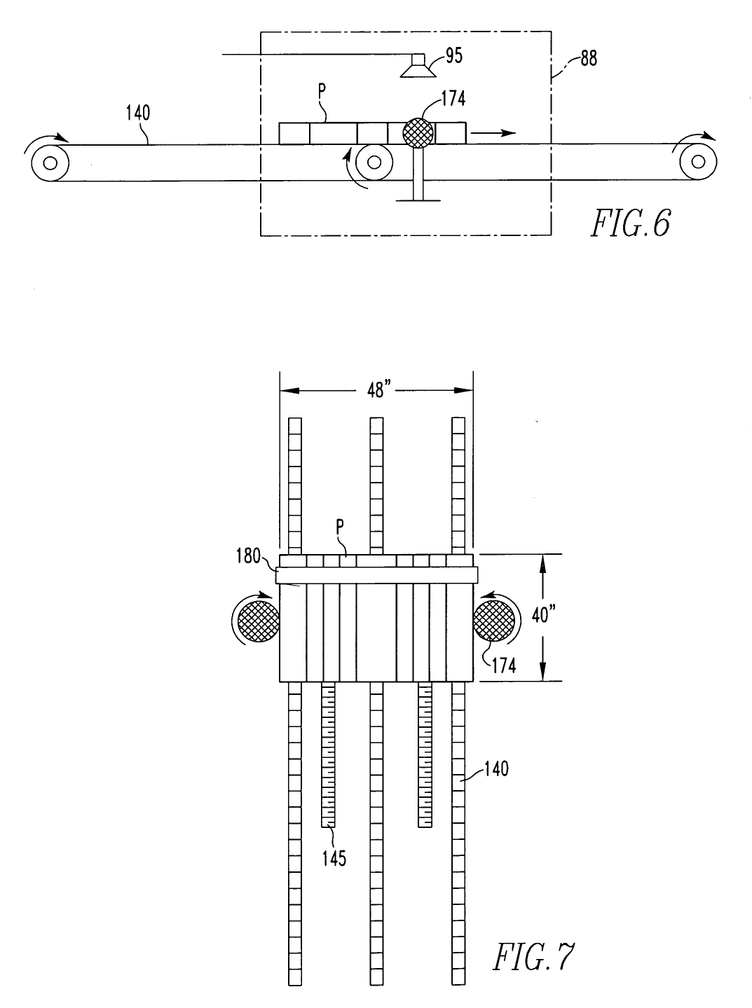

FIGS. 2 and 3 show a pallet “P” passing through the first, second and third regions of first stage area 20 for a second embodiment of this invention. While traveling along first conveyor 40, used pallet “P” enters dust hood 88 where its top exterior surface is forced under a power driven, rotating steel brush 78 measuring about 10 inches in diameter and 54 inches in cross-sectional length (“first region”). In this alternate embodiment, a second, similarly sized brush 178 cleans the bottom exterior of pallet “P” (“second region”) near simultaneously. Two steel rotary brushes 74, each about 6 inches long and 10 inches in diameter, then clean both latitudinal side exteriors of pallet “P” (“third region”). All of this transpires while vacuum heads 95 remove debris scraped from most exterior surfaces of pallet “P”. Later, another set of similarly sized, steel rotary brushes 174 will clean the opposite, longitudinal side exteriors after pallet “P” makes a right angle turn from first conveyor 40 onto second conveyor 140. See generally, FIG. 6 for a representative view of this alternative “fourth region” configuration for first stage area 20.

In this second embodiment, the pallet interior top, bottom and side surfaces are next commonly cleaned by inserting into each interior of pallet “P” a plurality of indexed brush heads 85. Such brush heads are designed to slide along preset track heads for allowing left-to-right, and top-to-bottom cleaning to effect a near simultaneous cleansing of the pallet interiors per regions five through eight of first stage area 20.

After all first stage area regions are finished, a fully scoured (both inside and outside) pallet “P” advances on conveyor 140 to a second stage 30. There, at least the pallet exteriors are treated by exposure to a non-chemical, non-liquidous germicidal treatment. Preferably, this is accomplished with a brief but effective barrage of ultraviolet light within tunnel or chamber 100. A representative treatment chamber, about 48 inches high, made and sold by American Air & Water, Inc., includes several GML425 lamps that can deliver at least about 72 WVC watts to the system. The lamps in chamber 100 should be Teflon-coated and protected with custom guard rails on which pallets “P” will slide.

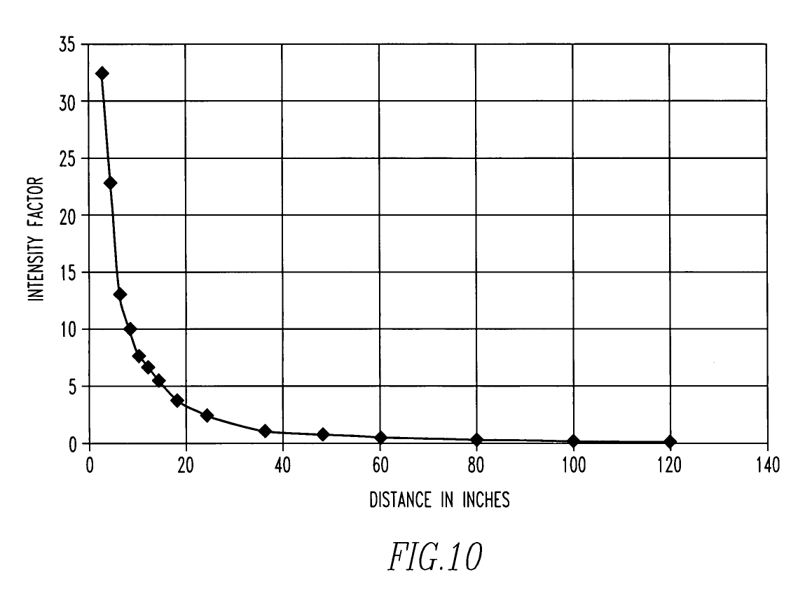

FIG. 10 shows the preferred distance (in inches) that UV light should be from the product it is being used to treat for achieving a preferred intensity. The greatest impact on treating used pallets to kill bacteria, molds, viruses and the like would be at less than 10 inches from the light source itself. In the table that follows, the desired intensity factor for pallet treatments with about 5 seconds of UV exposure, using a lamp rated at about 495.00 micro-watts/sq. centimeter or better shows a preferred distancing about 4 to 6 inches from the lamp source.

TABLE

| Distance | | UV Dosage/second | Total Dosage |
|---|---|---|---|
| (inches) | Intensity Factor | (microW/sq · cm) | (microW/sq · cm) |
| 2 | 32.300 | 15988.50 | 79942.50 |
| 4 | 22.800 | 11286.00 | 56430.00 |
| 6 | 12.900 | 6385.50 | 31927.50 |
| 8 | 9.850 | 4875.75 | 24378.75 |
| 10 | 7.490 | 3707.55 | 18537.75 |
| 12 | 6.480 | 3207.60 | 16038.00 |
| 14 | 5.350 | 2648.25 | 13241.25 |
| 18 | 3.600 | 1782.00 | 8910.00 |
| 24 | 2.330 | 1153.35 | 5766.75 |
| 36 | 1.000 | 495.00 | 2475.00 |
| 48 | 0.681 | 337.10 | 1685.48 |
| 60 | 0.452 | 223.74 | 1118.70 |
| 80 | 0.256 | 126.72 | 633.60 |
| 100 | 0.169 | 83.66 | 418.28 |
| 120 | 0.115 | 56.93 | 284.63 |

If a given reuse application for the treated pallet dictates, the inside surfaces may be optionally treated with their own UV light exposure. That may be accomplished by adding another conveyor stop mechanism, additional UV bulbs (at least four) and some servo drives for indexing these bulbs to the open side areas of each pallet to be treated. That will affect, if needed, an exposure to all scoured under side surface board areas.

The present invention may be embodied in other specific forms without departing from its spirit or essential characteristics. The described embodiments are to be considered in all respects only as illustrative, not restrictive. The scope of the invention is, therefore, indicated by the appended claims rather than by the foregoing description. All changes that come within the meaning and range of equivalency of the claims are to be embraced within their scope.

What is claimed is:

1. A system for cleaning pallets for reuse, said system comprising:
(i) a first stage area for cleaning an interior and exterior surface for each pallet, said first stage area including:
(a) a first region for cleaning a pallet top exterior;
(b) a second region for cleaning a pallet bottom exterior;
(c) a third region for cleaning a first pair of pallet side exteriors;
(d) a fourth region for cleaning a second pair of pallet side exteriors;
(e) a fifth region for cleaning a pallet top interior;
(f) a sixth region for cleaning a pallet bottom interior;
(g) a seventh region for cleaning a first pair of pallet side interiors; and
(h) an eighth region for cleaning a second pair of pallet side interiors;
(ii) a second stage area for subjecting each pallet exterior to a non-chemical, germicidal treatment; and
(iii) means for passing pallets through the system.

2. The pallet cleaning system of claim 1, wherein the first stage area operates without water.

3. The pallet cleaning system of claim 1, wherein the first stage area includes a plurality of brushes.

4. The pallet cleaning system of claim 3, wherein said brushes are spring mounted and treated with a non-stick coating.

5. The pallet cleaning system of claim 3, wherein the first stage area further includes means for removing debris brushed from each pallet exterior and interior.

6. The pallet cleaning system of claim 5, wherein the debris removing means includes at least one of: a plurality of vacuum heads and separate ridged chambers in which the brushes are stored when not in use.

7. The pallet cleaning system of claim 5, wherein the first stage area further includes a brushing tunnel through which each pallet passes.

8. The pallet cleaning system of claim 1 which further includes a stop mechanism for temporarily holding pallets in a stage or region.

9. The pallet cleaning system of claim 8, wherein said stop mechanism includes a mechanical sensor.

10. The pallet cleaning system of claim 8, wherein said stop mechanism includes a visual sensor.

11. The pallet cleaning system of claim 1, wherein the first and second regions of the first stage area are adjacent to each other.

12. The pallet cleaning system of claim 11, wherein pallet exterior cleaning in the first and second regions of the first stage area is performed near simultaneously.

13. The pallet cleaning system of claim 1, wherein the third and fourth regions of the first stage area are situated about ninety degrees apart.

14. The pallet cleaning system of claim 1, wherein pallet interior cleaning in the fifth and sixth regions of the first stage area is performed near simultaneously.

15. The pallet cleaning system of claim 1, wherein pallet interior cleaning in the seventh and eighth regions of the first stage area is performed near simultaneously.

16. The pallet cleaning system of claim 1, wherein said second stage area includes exposing each pallet to ultraviolet radiation.

17. The pallet cleaning system of claim 1 which further includes subjecting each pallet interior to the non-chemical, germicidal treatment.

18. The pallet cleaning system of claim 1, wherein said pallets are made of wood.

19. A dry system for disinfecting used wooden pallets, said system comprising:
(i) a first stage area that includes:
(a) a first region for brushing a top exterior of each pallet;
(b) a second region for brushing a bottom exterior of each pallet;
(c) a third region for brushing a first pair of side exteriors of each pallet;
(d) a fourth region for brushing a second pair of pallet side exteriors;
(e) a fifth region for brushing a top interior of each pallet;
(f) a sixth region for brushing a bottom interior of each pallet; and
(g) a seventh region for brushing at least one pair of side interiors of each pallet;
(ii) a second stage area for subjecting each pallet exterior to a non-chemical, germicidal treatment; and
(iii) a conveyor for transporting said pallets through the system.

20. The pallet disinfecting system of claim 19, wherein the first stage area includes a plurality of spring-mounted, abrasive brushes.

21. The pallet disinfecting system of claim 20, wherein the brushes are treated with a non-stick coating.

22. The pallet disinfecting system of claim 21, wherein the non-stick coating is Teflon®.

23. The pallet disinfecting system of claim 19, wherein the first stage area further includes a plurality of vacuum heads for removing debris brushed from each pallet exterior and interior.

24. The pallet disinfecting system of claim 19, wherein the first stage area further includes ridged chambers in which the brushes are separately stored when not in use.

25. The pallet disinfecting system of claim 19 which further includes a stop mechanism for temporarily holding pallets in an area.

26. The pallet disinfecting system of claim 19, wherein said second stage area includes exposing each pallet to ultraviolet radiation.

27. The pallet disinfecting system of claim 19 which further includes subjecting each pallet interior to the germicidal treatment.

28. A dry method for refurbishing wooden pallets for reuse, said method includes conveying pallets through a system comprising:
a first stage area having a first region for brushing a top exterior of each pallet, a second region for brushing a bottom exterior of each pallet, a third region for brushing a first pair of side exteriors of each pallet, a fourth region for brushing a second pair of pallet side exteriors, a fifth region for brushing a top interior of each pallet, a sixth region for brushing a bottom interior of each pallet, and a seventh region for brushing at least one pair of side interiors of each pallet; and
a second stage area for exposing each pallet exterior to an ultraviolet germicidal treatment.

29. The pallet refurbishing method of claim 28, wherein pallet exterior brushing in the first and second regions of the first stage area is performed near simultaneously.

30. The pallet refurbishing method of claim 28, wherein the third and fourth regions of the first stage area are in a space relationship about 90° apart.

31. The pallet refurbishing method of claim 28, wherein pallet interior brushing in the fifth and sixth regions of the first stage area is performed near simultaneously.
